(19) United States
(12) Patent Application Publication
(10) Pub. No.: US 2017/0220321 A1
(43) Pub. Date: Aug. 3, 2017

(54) COMPUTING PROCESSOR

(71) Applicant: Suejung HUH, Los Angeles, CA (US)

(72) Inventor: Suejung HUH, Los Angeles, CA (US)

(21) Appl. No.: 15/421,317

(22) Filed: Jan. 31, 2017

Related U.S. Application Data
(60) Provisional application No. 62/290,115, filed on Feb. 2, 2016.

(51) Int. Cl. G06F 7/552

(52) U.S. Cl. CPC G06F 7/552; G06F 2207/552

(57) ABSTRACT

Improved computing processor. In an embodiment, one or more roots of a perturbed polynomial equation, comprising a plurality of terms, are computed, assuming a non-zero coefficient for a highest-order one of the plurality of terms. For at least a highest-order term, an error upper bound of an unperturbed coefficient of the term is computed, it is determined whether a perturbed coefficient of the term is less than or equal to the error upper bound, and, when the perturbed coefficient of the term is less than or equal to the error upper bound, one or more roots of the perturbed polynomial equation are computed, assuming a zero coefficient for the term. Each computed root is added to a root set.

### CROSS-REFERENCE TO RELATED APPLICATION

This application claims priority to U.S. Provisional Patent App. No. 62/290,115, filed on Feb. 2, 2016, the entirety of which is hereby incorporated herein by reference.

### BACKGROUND

Field of the Invention

The embodiments described herein are generally directed to an improved computing processor, and, more particularly, to improved root-finding for a polynomial equation, for example, in the context of graphics processing.

Description of the Related Art

The polynomial equation refers generally to an expression of two or more algebraic terms, and more commonly to the sum of multiple algebraic terms that comprise different powers of the same variable, as in the form:

aₙxⁿ+aₙ₋₁xⁿ⁻¹+ . . . +a₂x²+a₁x+a₀=0

A polynomial equation may be of any degree. For instance, for a degree of one, the polynomial equation is a linear equation:

ax+b=0

For a degree of two, the polynomial equation is a quadratic equation:

ax²+bx+c=0

For a degree of three, the polynomial equation is a cubic equation:

ax³+bx²+cx+d=0

Similarly, for a degree of four, the polynomial equation is a quartic equation, for a degree of five, the polynomial equation is a quintic equation, and so on.

In some cases, univariate polynomial equations can be expressed in terms of variable x, with the qualification that a≠0. If a=0, a division by zero would ordinarily occur. Thus, in the event that a=0, an alternative equation must be used to solve for variable x. For example, the quadratic equation can be expressed by the following alternative equations:

$$\begin{matrix}\begin{matrix}if a \neq 0 , & x = \frac{- b \pm \sqrt{{b}^{2} - 4 ac}}{2 a}\end{matrix} & Equation ( 1 ) \\ \begin{matrix}if a = 0 , & x = \frac{- c}{b}\end{matrix} & Equation ( 2 )\end{matrix}$$

However, as a result of round-off errors £ that occur during numerical computations, numerically-computed polynomials are perturbed polynomials, which may be represented as:

âₙxⁿ+âₙ₋₁xⁿ⁻¹+ . . . +â₂x²+â₁x+â₀=0,

where âᵢ=aᵢ+εᵢ,

where εᵢ is an arbitrarily small number representing accumulated round-off errors

It is well known that the solution to a polynomial equation is very sensitive to the small perturbations caused by round-off errors. For instance, due to the perturbation caused by round-off error εₙ, âₙ may be non-zero when aₙ is zero. Consequently, given an âₙ, it is unknown whether or not aₙ is zero. Using the perturbed quadratic equation as an example, given â, it is unknown whether Equation (1) or Equation (2) will produce the correct solution.

### SUMMARY

Accordingly, systems, methods, and media are disclosed to improve the efficiency of a processor in computing the roots of a polynomial equation.

In an embodiment, a method for improving the efficiency of at least one hardware processor is disclosed. The method comprises, by the at least one hardware processor computing one or more roots of a perturbed polynomial equation, comprising a plurality of terms, with a non-zero coefficient for a highest-order one of the plurality of terms; adding the computed one or more roots to a root set; and, for at least the highest-order term, performing first processing comprising computing an error upper bound of an unperturbed coefficient of the term, determining whether a perturbed coefficient of the term is less than or equal to the error upper bound, and, when the perturbed coefficient of the term is less than or equal to the error upper bound, computing one or more roots of the perturbed polynomial equation with a zero coefficient for the term, and adding the computed one or more roots to the root set.

In an additional embodiment, a system is disclosed. The system comprises at least one hardware processor that: computes one or more roots of a perturbed polynomial equation, comprising a plurality of terms, with a non-zero coefficient for a highest-order one of the plurality of terms; adds the computed one or more roots to a root set; and, for at least the highest-order term, performs first processing comprising computing an error upper bound of an unperturbed coefficient of the term, determining whether a perturbed coefficient of the term is less than or equal to the error upper bound, and, when the perturbed coefficient of the term is less than or equal to the error upper bound, computing one or more roots of the perturbed polynomial equation with a zero coefficient for the term, and adding the computed one or more roots to the root set.

In an additional embodiment, a non-transitory computer-readable storage medium having instructions stored thereon is disclosed. The instructions, when executed by a processor, cause the processor to: compute one or more roots of a perturbed polynomial equation, comprising a plurality of terms, with a non-zero coefficient for a highest-order one of the plurality of terms; add the computed one or more roots to a root set; and, for at least the highest-order term, perform first processing comprising computing an error upper bound of an unperturbed coefficient of the term, determining whether a perturbed coefficient of the term is less than or equal to the error upper bound, and, when the perturbed coefficient of the term is less than or equal to the error upper bound, computing one or more roots of the perturbed polynomial equation with a zero coefficient for the term, and adding the computed one or more roots to the root set.

In any of the embodiments, the first processing may be performed for each of at least a subset of the plurality of terms from highest-order to lowest-order until the perturbed coefficient of the term being processed exceeds the error upper bound.

As an example, for collision detection, the perturbed polynomial equation may be a perturbed coplanarity equation, and the root set may represent a time of intersection between two objects. As another example, the perturbed polynomial equation may be a perturbed quadratic equation, such that computing one or more roots of the perturbed polynomial equation with a non-zero coefficient for the highest-order term comprises solving

$$x = \frac{- b \pm \sqrt{{b}^{2} - 4 ac}}{2 a}$$

and computing one or more roots of the perturbed polynomial equation with a zero coefficient for the highest-order term comprises solving

$$x = \frac{- c}{b}$$

wherein x is a root of the perturbed quadratic equation, a is the coefficient for the highest-order term, b is the coefficient for the second-highest-order term, and c is a coefficient for the third-highest-order term.

In an embodiment, the at least one hardware processor is a graphics processing unit (GPU). This GPU may be comprised in a video graphics card. As an alternative example, the at least one hardware processor may be comprised in a navigational system.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates a process of root finding, according to an embodiment;

FIG. 2 illustrates a process of computing an error upper bound in a described example, according to an embodiment; and

FIG. 3 illustrates a processing system on which one or more of the processes described herein may be executed, according to an embodiment.

### DETAILED DESCRIPTION

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

Process Overview

Embodiments of process(es) for improving a processor's ability to find the roots of a polynomial equation will now be described in detail. It should be understood that the described process(es) may be embodied in one or more software modules that are executed by one or more hardware processors. The described process may implemented as instructions represented in source code, object code, and/or machine code. These instructions may be executed directly by the hardware processor(s), or alternatively, may be executed by a virtual machine operating between the object code and the hardware processors. In addition, the implementation of the disclosed process(es) may be built upon or interfaced with one or more existing systems.

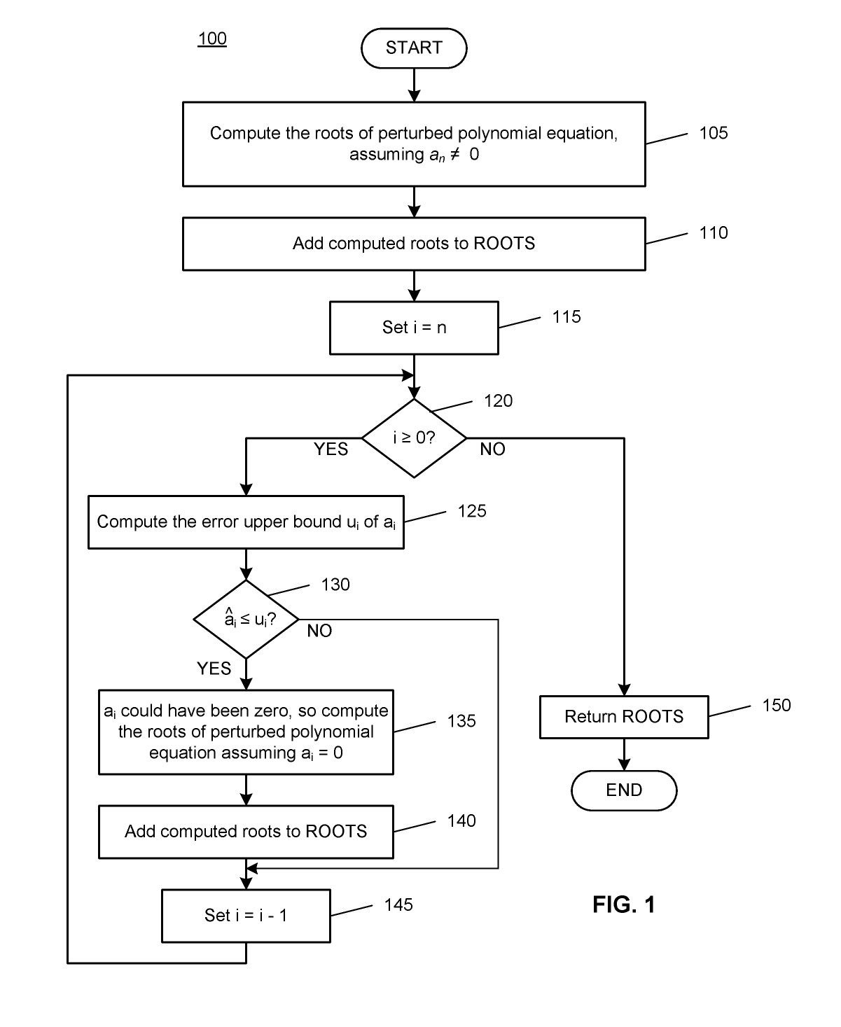

FIG. 1 illustrates a process 100 for improving root-finding for a polynomial equation, according to an embodiment. In step 105, the roots of a perturbed polynomial equation may be calculated in a conventional manner, under the assumption that aₙ≠0. The perturbed polynomial equation may take the form:

âₙxⁿ+âₙ₋₁xⁿ⁻¹+ . . . +â₂x²+â₁x+â₀=0,

where âᵢ=aᵢ+ε,

where ε is an arbitrarily small number representing accumulated round-off errors

In step 110, the roots calculated in step 105 are added to a set of roots. This set of roots may be stored in memory, for example, in a data structure, such as an array, linked list, or the like.

In step 115, a variable i is set to n, representing the degree of the perturbed polynomial equation. For example, if the perturbed polynomial equation is a quadratic equation, n would be two. If the perturbed polynomial equation is a cubic equation, n would be three.

In step 120, it is determined whether i is greater than or equal to zero. If i≧0 (i.e., “Yes” at step 120), process 100 continues to step 125. Otherwise, if i<0 (i.e., “No” at step 120), process 100 continues to step 150.

In step 125, the error upper bound uᵢ for aᵢ is computed. In an embodiment, the error upper bound is computed according to Theorem 1 below:

Theorem 1

When â and \hat{b} are the approximated representations of exact values
a and b, assume
|â| ≦ A(1 + ε)^{k}^{ₐ}
|\hat{b}| ≦ B(1 + ε)^{k}^{_{b}}
where kₛ = max{kₐ, k_{b}}, b = min{|b|, |\hat{b}|}, and A, B, k_{S}, kₐ, and k_{b} are
determined at each operation. When a is a terminal number, A = |a| and
kₐ = 1. Likewise, when b is a terminal number, B = |b| and k_{b} = 1.
Using ⊕, [symbol] , [symbol] , and [symbol] to represent floating-point addition,
multiplication, division, and square root, respectively, the upper and
lower bounds of the values represented by numerical operations are such
that
Upper Bound in Addition and Subtraction is:
|â ⊕ \hat{b}| ≦ (A ± B)(1 + ε)^{k}^{_{S}}⁺¹
Upper Bound in Multiplication is:
|â ⊕ \hat{b}| ≦ (A ± B)(1 + ε)^{k}^{ₐ}^{+k}^{_{b}}⁺¹
Upper Bound in Square Root is:
$\leq \sqrt{A} {( 1 + ε )}^{\frac{{k}_{a}}{2} + 1}$

Theorem 1 can be used to estimate rounding errors for various types of operations, as discussed in further detail below.

In step 130, perturbed term êᵢ is compared to the error upper bound uᵢ. If âᵢ≦uᵢ (i.e., “Yes” at step 130), process 100 continues to step 135. Otherwise, if âᵢ>uᵢ (i.e., “No” at step 130), process 100 continues to step 150.

In step 135, since âᵢ≦uᵢ, aᵢ could have been zero. Thus, the roots of the perturbed polynomial are computed assuming that aᵢ=0. For example, if the perturbed polynomial equation is the quadratic equation, then Equation (2) would be used to compute the root x. Similarly, an equation that assumes aᵢ=0 can be chosen for any other degree of polynomial equation.

In step, 140, the roots calculated in step 135 are added to the set of roots (i.e., the same set of roots to which the roots, calculated in step 105, were added). This set of roots may be stored in memory, for example, in a data structure, such as an array, linked list, or the like.

In step 145, variable i is decremented by one, and process 100 returns to step 120.

In step 150, the set of roots, compiled from the roots added in step 110 and/or step 140, is returned as the output of process 100. Advantageously, process 100 bounds the error in computed roots for polynomial equations, thereby avoiding unreliable roots with unbounded errors.

Estimating Rounding Errors Using Theorem 1

An example of estimating rounding errors using Theorem 1 will now be described, according to an embodiment. These examples represent potential implementations of step 125 in process 100.

For the example, consider the following case:

ax+b=0

where the problem is to determine whether two moving points, P and Q, are meeting at one point within the time interval [0,1], where P and Q are moving in one dimension (i.e., along a straight line).

The initial position of P is P₀, and the end position of P is P₁. Similarly, the initial position of Q is Q₀, and the end position of Q is Q₁. Pₜ denotes the position of P at time t, and is defined as

Pₜ=P₀+(P₁−P₀)t

Similarly, Qₜ denotes the position of Q at time t, and is defined as

Qₜ=Q₀+(Q₁−Q₀)t

When the two points P and Q meet, Pₜ=Qₜ. From this relation,

(V_{P}−V_{Q})t+(P₀−Q₀)=0,with V_{P}=P₁−P₀ and V_{Q}=Q₁−−Q₀

Thus, in the linear equation ax+b=0, a=(V_{P}−V_{Q}) and b=(P₀−Q₀).

Computation of the error upper bound for the coefficients a and b will now be described. In the analytic solution of the equation ax+b=0 in exact arithmetic, there are three cases:
[case 1] if a #0, then there is a single unique root x=b/a.
[case 2] if a=0 and b #0, then there is no root, i.e., the equation does not have a solution.
[case 3] if a=b=0, then there are infinite roots, i.e., the equation has infinite solutions, since basically any x satisfies the equation.

The implications of errors in numerical computations can be illustrated with an example. Assume a′ and b′ denote the computed values of the exact values a and b, and consider the case in which a=0 and b≠0, but a′≠0 and b′≠0. That is to say, the computed coefficients a′ and b′ are non-zero, while the actual coefficient a is zero. Thus, in this instance, numerical computations will result in a unique solution (since a′≠0, i.e., case 1 above), even though there is no actual solution (since a=0 and b≠0, i.e., case 2 above). In other words, the errors in the numerical computations have resulted in a unique root when there is none.

Process 100 detects this possibility that errors in numerical computations have resulted in perturbed coefficient a′≠0, while actual coefficient a=0, by computing the error upper bound of coefficient a in step 125.

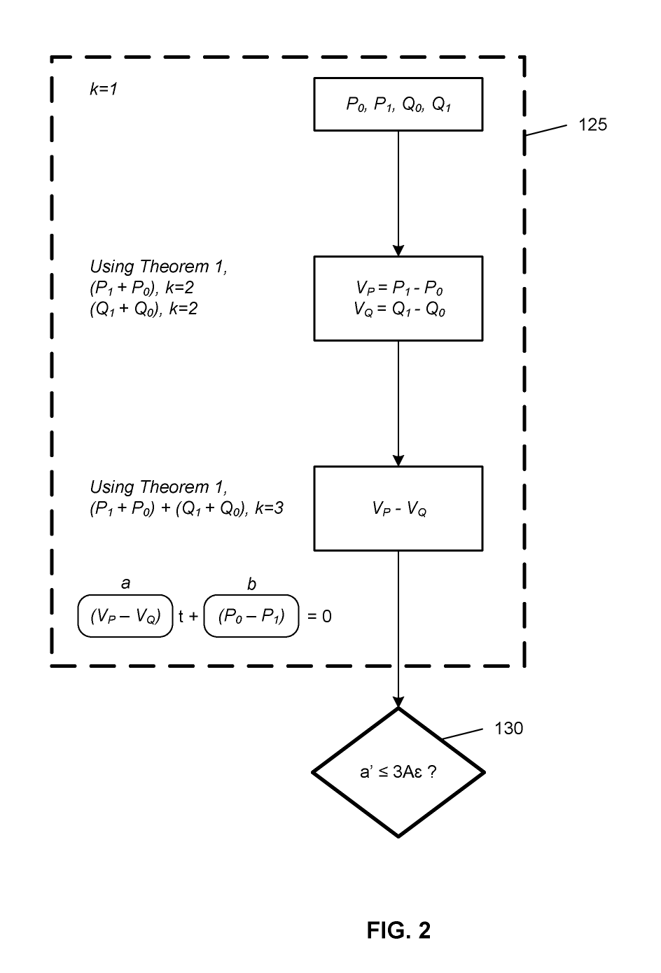

FIG. 2 illustrates a process of computing the error upper bound in the computation of coefficient a in the example above, according to an embodiment of step 125.

A first error is introduced in the computation of V_{P}=P₁−P₀ and V_{Q}=Q₁−Q₀. Thus, in a first step, per Theorem 1, the values A of V_{P} and V_{Q} are computed to be (P₁+P₀) and (Q₁+Q₀), respectively, with k=2.

A second error is introduced in the subtraction operation of V_{P}−V_{Q}. Thus, in a second step, per Theorem 1, the values A and k of the coefficient a are computed, such that A=(P₁+P₀+Q₁+Q₀), with k=3.

In step 130, the value of the computed coefficient a is compared with kAε=3(P₁+P₀+Q₁+Q₀)ε. If the computed coefficient a′ is smaller than or equal to kAε, then it is possible that the actual coefficient a could have been zero. Notably, the size of ε is determined by the precision of a computer. In this example, ε=2⁻⁵³, since double-precision computing is assumed.

Applications

Numerical solutions are computed with given numerical coefficients. Using the process 100, the cases in which the exact coefficients could have been zero are distinguished from cases in which the exact coefficients could not have been zero. Identifying such cases enables the computation of more accurate numerical solutions to polynomial equations in virtually any application that utilizes polynomial equations.

For instance, in an embodiment, process 100 may be implemented in a collision detection algorithm. Collision detection refers to the detection of the intersection (e.g., time of intersection) between two or more objects, for example, in video games, simulations, navigation, robotics, etc. A collision time may be computed as the root of a perturbed polynomial equation. The failure to appropriately consider the case that a=0 for the perturbed polynomial equation can result in false negatives (e.g., the failure to detect a collision, the detection of an incorrect collision time, etc.). Advantageously, process 100 efficiently eliminates such false negatives by considering the case that a=0 when the error upper bound indicates that such a case is a possibility. Process 100 may be especially useful in the detection of a time of collision between two primitive objects, between a face and vertex, and/or between an edge and another edge.

In an embodiment, process 100 may be implemented in an algorithm (e.g., collision detection algorithm) executed, for example, by the graphics processing unit (GPU) of a video graphics card. Alternatively, process 100 may be implemented in an algorithm executed by any general-purpose or special-purpose processor. Process 100 may be beneficial for any processor that executes an algorithm to numerically compute the roots of a polynomial equation in which coefficient a may be zero. Such algorithms may include, without limitation:
Solutions to the cubic equation in collision detection, used, for example, in virtual reality, augmented reality, video games (e.g., intersection of a character with a wall), physics-based simulations (intersection of a trainee-piloted vehicle with another vehicle), navigation (e.g., intersection of a spacecraft with a celestial location), surgery (e.g., intersection between a medical instrument and an organ), and/or the like;
Collision avoidance in the trajectory computations for robots;
Trajectory computations for a rocket launch;
Computations of rocket fuel burning rates; and/or
Computations of plasma sound velocity and dispersion relation in plasma physics.

Example Processing Device

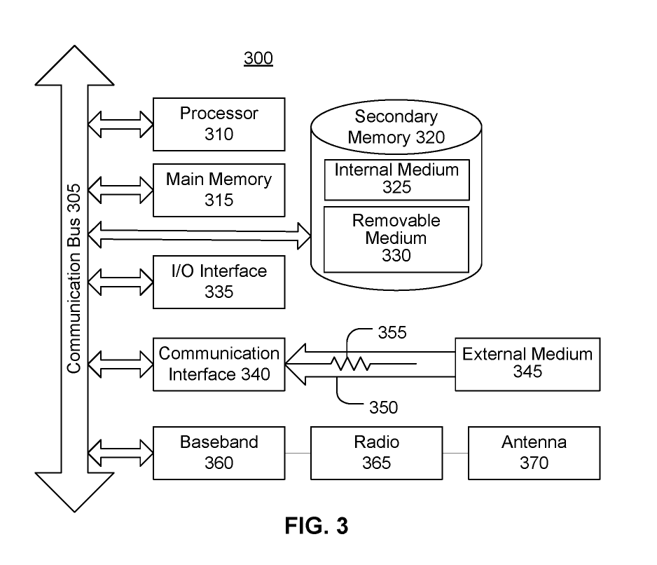

FIG. 3 is a block diagram illustrating an example wired or wireless system 300 that may be used in connection with various embodiments described herein. For example system 300 may be used to implement process 100 described above with reference to FIG. 1. System 300 can be a server, a conventional personal computer, a video graphics card, a navigational system, or any other processor-enabled device that is capable of wired and/or wireless data communication.

System 300 preferably includes one or more processors, such as processor 310. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 310. Examples of processors which may be used with system 300 include, without limitation, the Pentium® processor, Core i7® processor, and Xeon® processor, all of which are available from Intel Corporation of Santa Clara, Calif.

Processor 310 is preferably connected to a communication bus 305. Communication bus 305 may include a data channel for facilitating information transfer between storage and other peripheral components of system 300. Communication bus 305 further may provide a set of signals used for communication with processor 310, including a data bus, address bus, and control bus (not shown). Communication bus 305 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 300 preferably includes a main memory 315 and may also include a secondary memory 320. Main memory 315 provides storage of instructions and data for programs executing on processor 310, such as one or more of the functions and/or modules discussed above. It should be understood that programs stored in the memory and executed by processor 310 may be written and/or compiled according to any suitable language, including without limitation C/C++, Java, JavaScript, Perl, Visual Basic, .NET, and the like. Main memory 315 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 320 may optionally include an internal memory 325 and/or a removable medium 330. Removable medium 330 is read from and/or written to in any well-known manner. Removable storage medium 330 may be, for example, a magnetic tape drive, a compact disc (CD) drive, a digital versatile disc (DVD) drive, other optical drive, a flash memory drive, etc.

Removable storage medium 330 is a non-transitory computer-readable medium having stored thereon computer-executable code (i.e., software) and/or data. The computer software or data stored on removable storage medium 330 is read into system 300 for execution by processor 310.

In alternative embodiments, secondary memory 320 may include other similar means for allowing computer programs or other data or instructions to be loaded into system 300. Such means may include, for example, an external storage medium 345 and a communication interface 340, which allows software and data to be transferred from external storage medium 345 to system 300. Examples of external storage medium 345 may include an external hard disk drive, an external optical drive, an external magneto-optical drive, etc. Other examples of secondary memory 320 may include semiconductor-based memory such as programmable read-only memory (PROM), erasable programmable read-only memory (EPROM), electrically erasable read-only memory (EEPROM), or flash memory (block-oriented memory similar to EEPROM).

As mentioned above, system 300 may include a communication interface 340. Communication interface 340 allows software and data to be transferred between system 300 and external devices (e.g. printers), networks, or other information sources. For example, computer software or executable code may be transferred to system 300 from a network server via communication interface 340. Examples of communication interface 340 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device. Communication interface 340 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 340 are generally in the form of electrical communication signals 355. These signals 355 may be provided to communication interface 340 via a communication channel 350. In an embodiment, communication channel 350 may be a wired or wireless network, or any variety of other communication links. Communication channel 350 carries signals 355 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (i.e., computer programs or software) is stored in main memory 315 and/or the secondary memory 320. Computer programs can also be received via communication interface 340 and stored in main memory 315 and/or secondary memory 320. Such computer programs, when executed, enable system 300 to perform the various functions of the disclosed embodiments as described elsewhere herein.

In this description, the term “computer-readable medium” is used to refer to any non-transitory computer-readable storage media used to provide computer-executable code (e.g., software and computer programs) to system 300. Examples of such media include main memory 315, secondary memory 320 (including internal memory 325, removable medium 330, and external storage medium 345), and any peripheral device communicatively coupled with communication interface 340 (including a network information server or other network device). These non-transitory computer-readable mediums are means for providing executable code, programming instructions, and software to system 300.

In an embodiment that is implemented using software, the software may be stored on a computer-readable medium and loaded into system 300 by way of removable medium 330, I/O interface 335, or communication interface 340. In such an embodiment, the software is loaded into system 300 in the form of electrical communication signals 355. The software, when executed by processor 310, preferably causes processor 310 to perform the features and functions described elsewhere herein.

In an embodiment, I/O interface 335 provides an interface between one or more components of system 300 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and the like.

System 300 also includes optional wireless communication components that facilitate wireless communication over a voice network and/or a data network. The wireless communication components comprise an antenna system 370, a radio system 365, and a baseband system 360. In system 300, radio frequency (RF) signals are transmitted and received over the air by antenna system 370 under the management of radio system 365.

In one embodiment, antenna system 370 may comprise one or more antennae and one or more multiplexers (not shown) that perform a switching function to provide antenna system 370 with transmit and receive signal paths. In the receive path, received RF signals can be coupled from a multiplexor to a low noise amplifier (not shown) that amplifies the received RF signal and sends the amplified signal to radio system 365.

In alternative embodiments, radio system 365 may comprise one or more radios that are configured to communicate over various frequencies. In an embodiment, radio system 365 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 365 to baseband system 360.

If the received signal contains audio information, then baseband system 360 decodes the signal and converts it to an analog signal. Then the signal is amplified and sent to a speaker. Baseband system 360 also receives analog audio signals from a microphone. These analog audio signals are converted to digital signals and encoded by baseband system 360. Baseband system 360 also codes the digital signals for transmission and generates a baseband transmit audio signal that is routed to the modulator portion of radio system 365. The modulator mixes the baseband transmit audio signal with an RF carrier signal generating an RF transmit signal that is routed to antenna system 370 and may pass through a power amplifier (not shown). The power amplifier amplifies the RF transmit signal and routes it to antenna system 370 where the signal is switched to the antenna port for transmission.

Baseband system 360 is also communicatively coupled with processor 310, which may be a central processing unit (CPU). Processor 310 has access to data storage areas 315 and 320. Processor 310 is preferably configured to execute instructions (i.e., computer programs or software) that can be stored in main memory 315 or secondary memory 320. Computer programs can also be received from baseband processor 360 and stored in main memory 310 or in secondary memory 320, or executed upon receipt. Such computer programs, when executed, enable system 300 to perform the various functions of the disclosed embodiments. For example, data storage areas 315 or 320 may include various software modules.

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit, or step is for ease of description. Specific functions or steps can be moved from one module, block, or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA, or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such that the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method for improving the efficiency of at least one hardware processor, the method comprising, by the at least one hardware processor:
computing one or more roots of a perturbed polynomial equation, comprising a plurality of terms, with a non-zero coefficient for a highest-order one of the plurality of terms;
adding the computed one or more roots to a root set; and,
for at least the highest-order term, performing first processing comprising
computing an error upper bound of an unperturbed coefficient of the term,
determining whether a perturbed coefficient of the term is less than or equal to the error upper bound, and,
when the perturbed coefficient of the term is less than or equal to the error upper bound, computing one or more roots of the perturbed polynomial equation with a zero coefficient for the term, and adding the computed one or more roots to the root set.

2. The method of claim 1, comprising performing the first processing for each of at least a subset of the plurality of terms from highest-order to lowest-order until the perturbed coefficient of the term being processed exceeds the error upper bound.

3. The method of claim 1, wherein the perturbed polynomial equation is a perturbed coplanarity equation, and wherein the root set represents a time of intersection between two objects.

4. The method of claim 1, wherein the perturbed polynomial equation is a perturbed quadratic equation.

5. The method of claim 4, wherein computing one or more roots of the perturbed polynomial equation with a non-zero coefficient for the highest-order term comprises solving:
$$x = \frac{- b \pm \sqrt{{b}^{2} - 4 ac}}{2 a}$$
wherein x is a root of the perturbed quadratic equation, a is the coefficient for the highest-order term, b is a coefficient for the second-highest-order one of the plurality of terms, and c is a coefficient for the third-highest-order one of the plurality of terms.

6. The method of claim 5, wherein computing one or more roots of the perturbed polynomial equation with a zero coefficient for the highest-order term comprises solving:
$$x = \frac{- c}{b}$$
wherein x is a root of the perturbed quadratic equation, b is the coefficient for the second-highest-order term, and c is a coefficient for the third-highest-order term.

7. The method of claim 1, wherein the at least one hardware processor is a graphics processing unit (GPU).

8. The method of claim 7, wherein the GPU is comprised in a video graphics card.

9. The method of claim 1, wherein the at least one hardware processor is comprised in a navigational system.

10. A system comprising at least one hardware processor that:
computes one or more roots of a perturbed polynomial equation, comprising a plurality of terms, with a non-zero coefficient for a highest-order one of the plurality of terms;
adds the computed one or more roots to a root set; and,
for at least the highest-order term, performs first processing comprising
computing an error upper bound of an unperturbed coefficient of the term,
determining whether a perturbed coefficient of the term is less than or equal to the error upper bound, and,
when the perturbed coefficient of the term is less than or equal to the error upper bound, computing one or more roots of the perturbed polynomial equation with a zero coefficient for the term, and adding the computed one or more roots to the root set.

11. The system of claim 10, wherein the at least one hardware processor performs the first processing for each of at least a subset of the plurality of terms from highest-order to lowest-order until the perturbed coefficient of the term being processed exceeds the error upper bound.

12. The system of claim 10, wherein the perturbed polynomial equation is a perturbed coplanarity equation, and wherein the root set represents a time of intersection between two objects.

13. The system of claim 10, wherein the perturbed polynomial equation is a perturbed quadratic equation.

14. The system of claim 13, wherein computing one or more roots of the perturbed polynomial equation with a non-zero coefficient for the highest-order term comprises solving:
$$x = \frac{- b \pm \sqrt{{b}^{2} - 4 ac}}{2 a}$$
wherein x is a root of the perturbed quadratic equation, a is the coefficient for the highest-order term, b is a coefficient for the second-highest-order one of the plurality of terms, and c is a coefficient for the third-highest-order one of the plurality of terms.

15. The system of claim 14, wherein computing one or more roots of the perturbed polynomial equation with a zero coefficient for the highest-order term comprises solving:
$$x = \frac{- c}{b}$$
wherein x is a root of the perturbed quadratic equation, b is the coefficient for the second-highest-order term, and c is a coefficient for the third-highest-order term.

16. The system of claim 10, wherein the at least one hardware processor is a graphics processing unit (GPU).

17. The system of claim 16, wherein the system is a video graphics card.

18. The system of claim 10, wherein the system is a navigational system.

19. A non-transitory computer-readable medium having instructions stored thereon, wherein the instructions, when executed by a processor, cause the processor to:
compute one or more roots of a perturbed polynomial equation, comprising a plurality of terms, with a non-zero coefficient for a highest-order one of the plurality of terms;
add the computed one or more roots to a root set; and,
for at least the highest-order term, perform first processing comprising
computing an error upper bound of an unperturbed coefficient of the term,
determining whether a perturbed coefficient of the term is less than or equal to the error upper bound, and,
when the perturbed coefficient of the term is less than or equal to the error upper bound, computing one or more roots of the perturbed polynomial equation with a zero coefficient for the term, and adding the computed one or more roots to the root set.

20. The non-transitory computer-readable medium of claim 19, wherein the instructions cause the processor to perform the first processing for each of at least a subset of the plurality of terms from highest-order to lowest-order until the perturbed coefficient of the term being processed exceeds the error upper bound.

21. The non-transitory computer-readable medium of claim 19, wherein the perturbed polynomial equation is a perturbed coplanarity equation, and wherein the root set represents a time of intersection between two objects.

22. The non-transitory computer-readable medium of claim 19, wherein the perturbed polynomial equation is a perturbed quadratic equation.

23. The non-transitory computer-readable medium of claim 22, wherein computing one or more roots of the perturbed polynomial equation with a non-zero coefficient for the highest-order term comprises solving:
$$x = \frac{- b \pm \sqrt{{b}^{2} - 4 ac}}{2 a}$$
wherein x is a root of the perturbed quadratic equation, a is the coefficient for the highest-order term, b is a coefficient for the second-highest-order one of the plurality of terms, and c is a coefficient for the third-highest-order one of the plurality of terms.

24. The non-transitory computer-readable medium of claim 23, wherein computing one or more roots of the perturbed polynomial equation with a zero coefficient for the highest-order term comprises solving:
$$x = \frac{- c}{b}$$
wherein x is a root of the perturbed quadratic equation, b is the coefficient for the second-highest-order term, and c is a coefficient for the third-highest-order term.
